(19) United States
(12) Patent Application Publication
(10) Pub. No.: US 2023/0084091 A1
(43) Pub. Date: Mar. 16, 2023

(54) MOTOR

(71) Applicant: DENSO CORPORATION, Kariya-city (JP)

(72) Inventor: Yuuji YAMASHITA, Kariya-city (JP)

(73) Assignee: DENSO CORPORATION, Kariya-city (JP)

(21) Appl. No.: 17/992,460

(22) Filed: Nov. 22, 2022

Related U.S. Application Data
(63) Continuation of application No. PCT/JP2021/009011, filed on Mar. 8, 2021.

(30) Foreign Application Priority Data
May 28, 2020 (JP) 2020-093559

(51) Int. Cl. H02K 3/52

(52) U.S. Cl. CPC H02K 3/522; H02K 2203/06

(57) ABSTRACT

A motor includes a rotor and a stator. The rotor is rotatably supported and includes a magnet. The stator is radially opposed to the rotor and includes a plurality of coils. Each of the coils is formed by winding an electrically-conductive conductor wire in a ring shape. The coils are arranged along a circumferential direction. Moreover, for each of the coils, the conductor wire forming the coil has a first end portion radially protruding from an inner peripheral portion of the coil and a second end portion radially protruding from an outer peripheral portion of the coil.

### CROSS-REFERENCE TO RELATED APPLICATIONS

The present application is a continuation application of International Application No. PCT/JP2021/009011 filed on Mar. 8, 2021, which is based on and claims priority from Japanese Patent Application No. 2020-093559 filed on May 28, 2020. The entire contents of these applications are incorporated by reference into the present application.

### BACKGROUND

### 1 Technical Field

The present disclosure relates to motors.

### 2. Description of Related Art

There is disclosed, for example in Japanese Patent Application Publication No. JP2004289963A, a slotless brushless motor that includes no slots where conductor wires forming coils are wound. In the slotless brushless motor, each circumferentially-adjacent pair of U-phase, V-phase and W-phase coils are arranged such that substantially halves of the pair of coils radially overlap each other. Consequently, it becomes possible to achieve reduction in the cogging torque of the slotless brushless motor.

### SUMMARY

However, the inventor of the present application has found the following problem with the motor disclosed in the above patent document. That is, in the motor disclosed in the above patent document, for arranging each circumferentially-adjacent pair of the coils to radially overlap each other, it is necessary to form, for each of the coils, a radial step in a circumferentially middle part thereof. Consequently, the shape of the coils becomes complicated.

The present disclosure has been accomplished in view of the above problem.

According to the present disclosure, there is provided a motor which includes a rotor and a stator. The rotor is rotatably supported and includes a magnet. The stator is radially opposed to the rotor and includes a plurality of coils. Each of the coils is formed by winding an electrically-conductive conductor wire in a ring shape. The coils are arranged along a circumferential direction. Moreover, for each of the coils, the conductor wire forming the coil has a first end portion radially protruding from an inner peripheral portion of the coil and a second end portion radially protruding from an outer peripheral portion of the coil.

With the above configuration of the motor according to the present disclosure, the shape of the coils is prevented from becoming complicated.

### BRIEF DESCRIPTION OF THE DRAWINGS

FIG. 1 is a perspective view of a speed reducer-equipped motor according to a first embodiment.

FIG. 2 is a cross-sectional perspective view of the speed reducer-equipped motor.

FIG. 3 is a side cross-sectional view showing a cross section of the speed reducer-equipped motor cut along an axial direction.

FIG. 4 is an exploded perspective view of the speed reducer-equipped motor.

FIG. 5 is an exploded perspective view of a stator of the speed reducer-equipped motor.

FIG. 6 is an exploded perspective view of a speed reducer of the speed reducer-equipped motor.

FIG. 7 is an exploded perspective view showing a magnet and magnet covering members of the speed reducer-equipped motor.

FIG. 8 is a perspective view showing a stator core and coils arranged along an inner circumferential surface of the stator core in the speed reducer-equipped motor.

FIG. 9 is a perspective view showing one of the coils.

FIG. 10 is a perspective view showing the stator core and the coils mounted to the stator core via corresponding insulators.

FIG. 11 is a perspective view, from a radially outer side, of one of the coils formed around the corresponding insulators.

FIG. 12 is a perspective view, from a radially inner side, of one of the coils formed around the corresponding insulators.

FIG. 13 is a schematic diagram illustrating the connection between the coils.

FIG. 14 is a schematic diagram illustrating the connection between the coils via connecting members.

FIG. 15 is a schematic diagram illustrating the arrangement of the connecting members on a radially outer side of the coils.

FIG. 16 is a perspective view, which corresponds to FIG. 11, showing a coil and an insulator of a motor according to a second embodiment.

FIG. 17 is a schematic diagram, which corresponds to FIG. 15, illustrating the arrangement of connecting members in the motor according to the second embodiment.

FIG. 18 is a perspective view, which corresponds to FIG. 12, showing a coil and an insulator of a motor according to a third embodiment.

FIG. 19 is a schematic diagram, which corresponds to FIG. 15, illustrating the arrangement of connecting members in the motor according to the third embodiment.

FIG. 20 is a perspective view, which corresponds to FIG. 12, showing a coil and an insulator of a motor according to a fourth embodiment.

FIG. 21 is a schematic diagram, which corresponds to FIG. 15, illustrating the arrangement of connecting members in the motor according to the fourth embodiment.

FIG. 22 is a schematic diagram, which corresponds to FIG. 13, illustrating the connection between coils of a first system in a motor according to a fifth embodiment.

FIG. 23 is a schematic diagram, which corresponds to FIG. 13, illustrating the connection between coils of a second system in the motor according to the fifth embodiment.

FIG. 24 is a schematic diagram, which corresponds to FIG. 15, illustrating the arrangement of connecting members in the motor according to the fifth embodiment.

FIG. 25 is an enlarged perspective view showing a coil and an insulator of a motor according to a sixth embodiment.

FIG. 26 is a perspective view, which corresponds to FIG. 11, showing a coil and an insulator of a motor according to a seventh embodiment.

### DESCRIPTION OF EMBODIMENTS

### First Embodiment

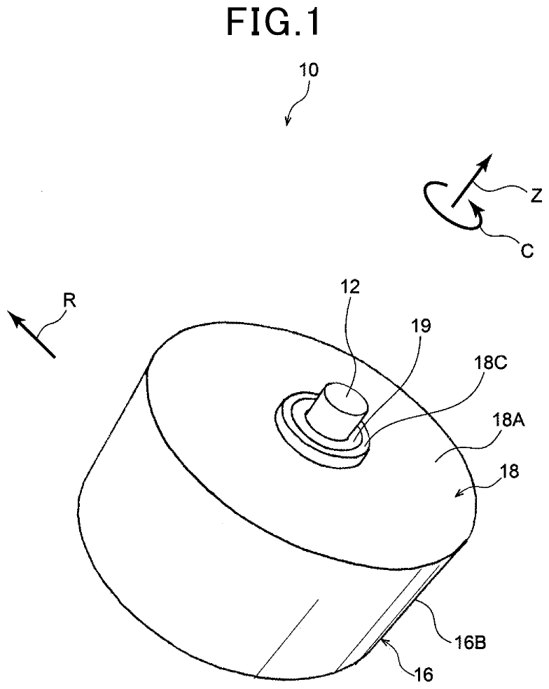

A speed reducer-equipped motor 10 according to the first embodiment will be described hereinafter with reference to FIGS. 1 to 7. It should be noted that the directions suitably indicated by arrows Z, R and C in the drawings respectively represent a first side in an axial direction of an output shaft 12 of the motor 10, an outer side in a radial direction of the output shaft 12 and a first side in a circumferential direction of the output shaft 12. Moreover, it also should be noted that unless otherwise specified, the axial direction, radial direction and circumferential direction of the output shaft 12 will be simply referred to as the axial direction, the radial direction and the circumferential direction hereinafter.

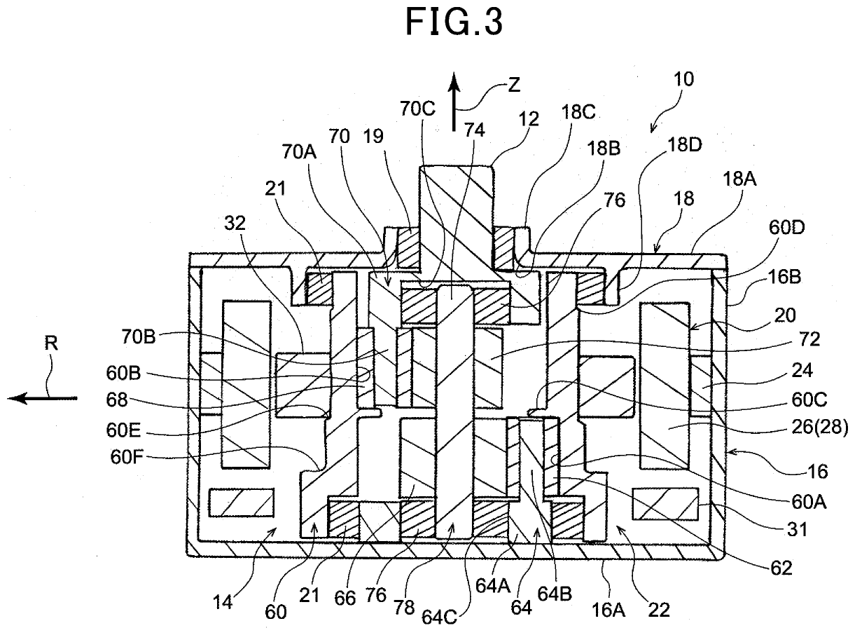

As shown in FIGS. 1 to 4, the speed reducer-equipped motor 10 according to the present embodiment is a 3-phase, 8-pole and 12-slot motor which has a speed reducer 14 built therein. Specifically, the speed reducer-equipped motor 10 includes a motor case 16, a motor cover 18, a stator 20, a rotor 22, the speed reducer 14 and the output shaft 12. The stator 20, the rotor 22 and the speed reducer 14 are arranged in the motor case 16. The speed reducer 14 is configured to reduce the speed of rotation of the rotor 22. The output shaft 12 protrudes to the first side in the axial direction from the motor cover 18. In addition, in FIG. 3, there is shown a cross section of the speed reducer-equipped motor 10.

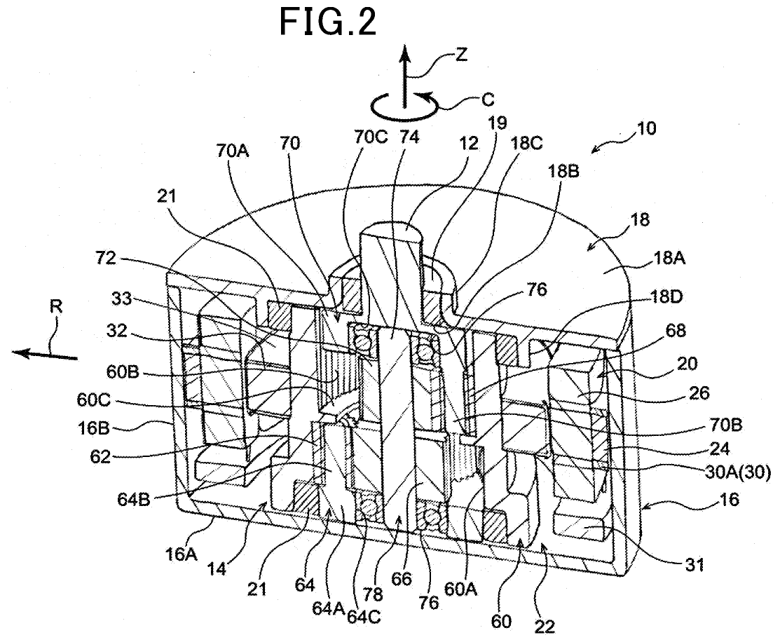

As shown in FIGS. 2, 3 and 5, the motor case 16 is formed in a bottomed cylindrical shape such that it is open on the first side in the axial direction, but closed on a second side in the axial direction. Specifically, the motor case 16 has a bottom wall portion 16A formed in a discoid shape, and a side wall portion 16B bending and extending from a radially outer end of the bottom wall portion 16A to the first side in the axial direction.

As shown in FIGS. 2 to 4, the motor cover 18 has a lid portion 18A formed in a discoid shape. In a radially central part of the lid portion 18A, there is formed an insertion hole 18B in which the output shaft 12 that will be described later is inserted. Moreover, the motor cover 18 has a first flange portion 18C formed in an annular shape and protruding from an edge portion of the insertion hole 18B to the first side in the axial direction. To a radially inner periphery of the first flange portion 18C, there is fixed, by press fitting or the like, a bearing 19 to support the output shaft 12. The motor cover 18 is mounted, with the output shaft 12 inserted in the insertion hole 18B of the motor cover 18, to the motor case 16. Consequently, the motor case 16 is closed by the lid portion 18A of the motor cover 18 on the open end side (i.e., the first side in the axial direction) of the motor case 16, with the output shaft 12 protruding from the motor cover 18 to the first side in the axial direction. Furthermore, as shown in FIGS. 2 and 3, the motor cover 18 also has a second flange portion 18D formed in an annular shape and protruding from a radially middle part of the lid portion 18A to the second side in the axial direction. To a radially inner periphery of the second flange portion 18D, there is fixed, by press fitting or the like, a first sealed bearing 21 to support a ring gear 60 of the speed reducer 14 that will be described later.

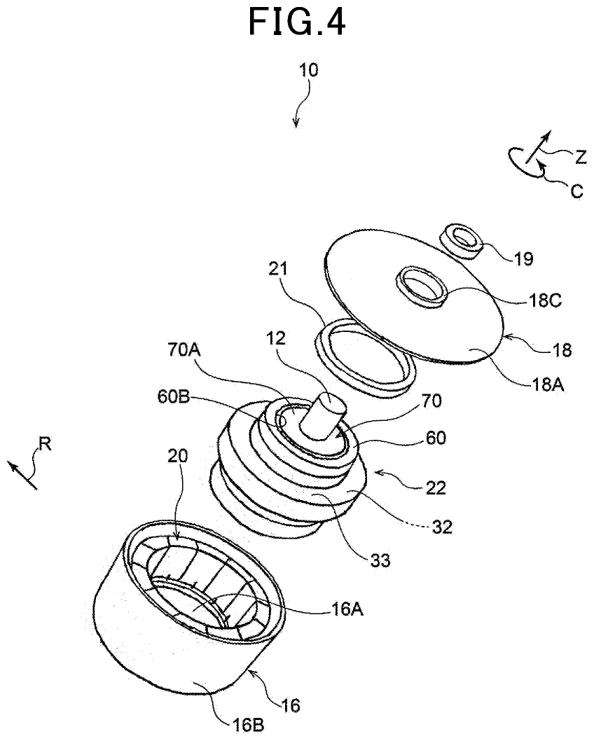

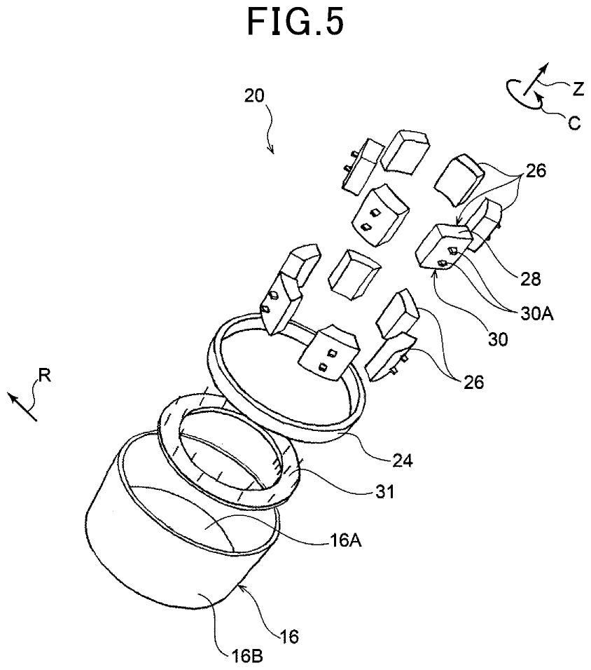

As shown in FIG. 4, the stator 20 is fixed to a radially inner surface of the side wall portion 16B of the motor case 16. Moreover, as shown in FIGS. 4 and 5, the stator 20 includes a stator core 24 formed in an annular shape, and a plurality of coil units 26 fixed to an inner circumferential surface of the stator core 24. More particularly, in the present embodiment, as shown in FIG. 5, twelve coil units 26 are arranged side by side in the circumferential direction.

Each of the coil units 26 is composed of a coil 28 formed by winding a conductor wire, and an insulator 30 that holds the shape of the coil 28 and has locking portions 30A locked to the stator core 24. The conductor wire forming the coil 28 is constituted of an element wire assembly that is formed by bundling a plurality of electrically-conductive element wires together. Moreover, the electrical resistances between the element wires are higher than the electrical resistance of each of the element wires. Consequently, it becomes possible to reduce eddy cu loss in the coil 28. Furthermore, end portions of the coils 28 of the coil units 26 are connected in a manner to be described in detail later. In addition, in the present embodiment, the stator 20 has a toothless structure such that no portions of the stator core 24 are located inside the coils 28.

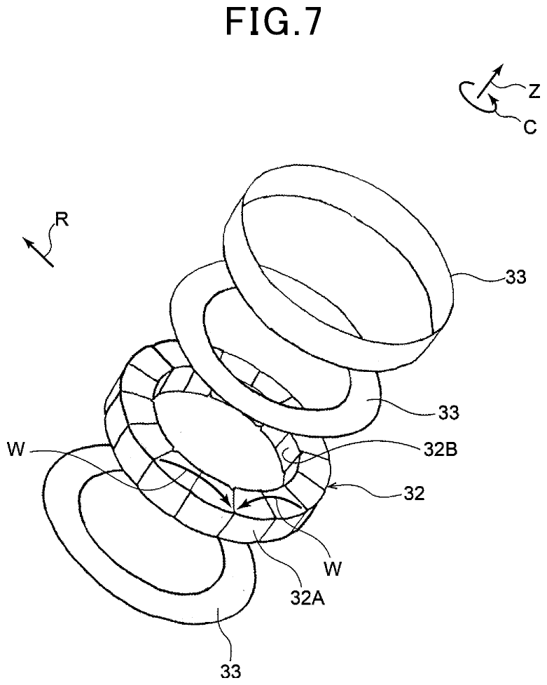

As shown in FIGS. 4 and 7, the rotor 22 is formed by mounting an annular magnet 32 to an outer circumferential surface of the ring gear 60 of the speed reducer 14 that will be described later. In the present embodiment, as shown in FIG. 7, the magnet 32 is implemented by an 8-pole polar anisotropic magnet in which N poles and S poles are alternately arranged in the circumferential direction. In addition, in FIG. 7, the directions of magnetic flux in parts of the magnet 32 are schematically indicated by arrows W. It should be noted that the magnet 32 may alternatively be implemented by magnets having other orientations, such as a magnet having a Halbach orientation. Moreover, in the present embodiment, the magnet 32 is formed of a magnetic compound whose coercive force Hc is higher than or equal to 400 [kA/m] and residual flux density Br is higher than or equal to 1.0[T]. For example, the magnet 32 may be formed of a magnetic compound such as NdFe₁₁TiN, Nd₂Fe₁₄B, Sm₂Fe₁₇N₃ or FeNi.

In the present embodiment, the orientation of magnetic flux in the magnet 32 is set so that the magnetic flux density measured along the circumferential direction on an outer circumferential surface (i.e., a radially outer surface) 32A of the magnet 32 has a peak value at the centers of the N and S magnetic poles. In addition, in the present embodiment, the orientation of magnetic flux in the magnet 32 is set so that the magnetic flux density measured along the circumferential direction on an inner circumferential surface (i.e., a radially inner surface) 32B of the magnet 32 is substantially zero at each position in the circumferential direction. Consequently, the ring gear 60, to which the magnet 32 is fixed, is prevented from becoming a part of a magnetic circuit (or magnetic path). In addition, the outer circumferential surface 32A of the magnet 32, which is mounted to the outer circumferential surface of the ring gear 60, is covered with a magnet covering member 33; and a surface of the magnet 32 on the first side in the axial direction and a surface of the magnet 32 on the second side in the axial direction are also covered with respective magnet covering members 33.

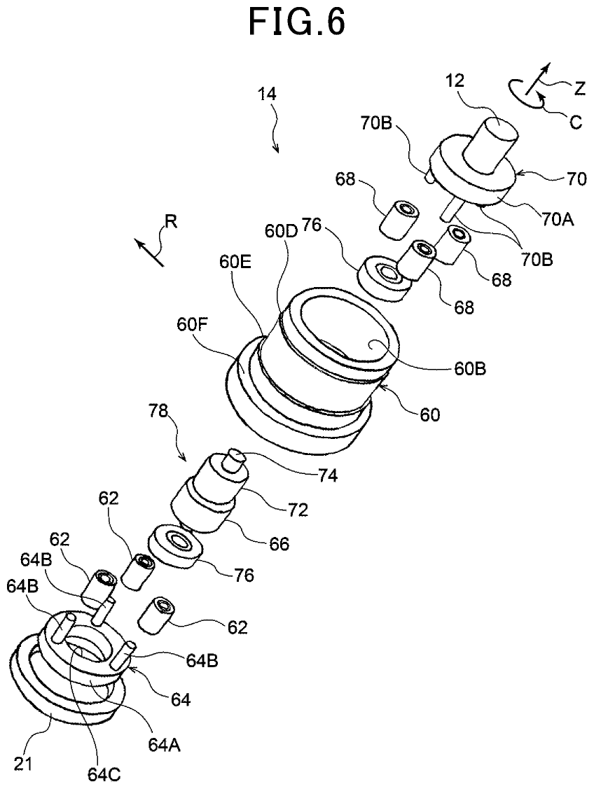

As shown in FIG. 6, the speed reducer 14 includes the aforementioned ring gear 60 that is formed in a cylindrical shape and constitutes a part of the rotor 22. Moreover, the speed reducer 14 further includes first planetary gears 62, a first carrier 64 and a first sun gear 66, all of which are arranged on the second side in the axial direction in an interior space of the ring gear 60. Furthermore, the speed reducer 14 also includes second planetary gears 68, a second carrier 70 and a second sun gear 72, all of which are arranged on the first side in the axial direction in the interior space of the ring gear 60.

As shown in FIGS. 2, 3 and 6, the ring gear 60 is formed of a metal material into the cylindrical shape. In addition, in the present embodiment, each component of the speed reducer 14 is made of a metal material. A plurality of first internal teeth 60A are formed along the circumferential direction on the radially inner surface of the ring gear 60 on the second side in the axial direction. On the other hand, a plurality of second internal teeth 60B are formed along the circumferential direction on the radially inner surface of the ring gear 60 on the first side in the axial direction. In the present embodiment, the inner diameter of that part of the radially inner periphery of the ring gear 60 where the first internal teeth 60A are formed is set to be larger than the inner diameter of that part of the radially inner periphery of the ring gear 60 where the second internal teeth 60B are formed. Moreover, at a boundary between that part of the radially inner periphery of the ring gear 60 where the first internal teeth 60A are formed and that part of the radially inner periphery of the ring gear 60 where the second internal teeth 60B are formed, there is formed a reduced-diameter portion 60C that protrudes radially inward. Furthermore, at the radially outer periphery of the ring gear 60, there are formed three step portions having different radial heights. Hereinafter, the three step portions will be referred to as a first step portion 60D, a second step portion 60E and a third step portion 60F in order from the first side in the axial direction. In the present embodiment, the outer diameter of that part of the radially outer periphery of the ring gear 60 which is located between the first step portion 60D and the second step portion 60E is set to be larger than the outer diameter of that part of the radially outer periphery of the ring gear 60 which is located on the first side in the axial direction with respect to the first step portion 60D. Moreover, the outer diameter of that part of the radially outer periphery of the ring gear 60 which is located between the second step portion 60E and the third step portion 60F is set to be larger than the outer diameter of that part of the radially outer periphery of the ring gear 60 which is located between the first step portion 60D and the second step portion 60E. Furthermore, the outer diameter of that part of the radially outer periphery of the ring gear 60 which is located on the second side in the axial direction with respect to the third step portion 60F is set to be larger than the outer diameter of that part of the radially outer periphery of the ring gear 60 which is located between the second step portion 60E and the third step portion 60F. Moreover, the second step portion 60E is formed at the same position in the axial direction as the reduced-diameter portion 60C. The magnet 32 is fixed to the outer circumferential surface of the ring gear 60, with a radially inner peripheral end of the magnet 32 on the second side in the axial direction locked to the second step portion 60E. Furthermore, an end portion of the ring gear 60, which is located on the first side in the axial direction with respect to the first step portion 60D, is supported by the first sealed bearing 21 fixed to the motor cover 18. On the other hand, a second sealed bearing 21 is fixed, by press fitting or the like, to a radially inner periphery of an end portion of the ring gear 60 which is located on the second side in the axial direction with respect to the third step portion 60F.

The first planetary gears 62 are arranged radially inside a part of the ring gear 60 on the second side in the axial direction. More particularly, in the present embodiment, there are arranged three first planetary gears 62 at equal intervals along the circumferential direction. In addition, the first planetary gears 62 each mesh with the first internal teeth 60A of the ring gear 60.

The first carrier 64 has a base plate portion 64A formed in a discoid shape, and three shaft portions 64B protruding from the base plate portion 64A to the first side in the axial direction and arranged at equal intervals in the circumferential direction. The three shaft portions 64B respectively rotatably support the three first planetary gears 62. In addition, the first planetary gears 62 are arranged adjacent to the reduced-diameter portion 60C of the ring gear 60; thus, the first planetary gears 62 are restricted by the reduced-diameter portion 60C of the ring gear 60 from moving in a direction of being detached from the shaft portions 64B of the first carrier 64. Moreover, a circular opening 64C is formed at the axial center of the base plate portion 64A. To an inner periphery of the opening 64C, there is fixed, by press fitting or the like, a bearing 76 to support an end portion of a shaft member 74 on the second side in the axial direction; the shaft member 74 will be described later. In the present embodiment, the base plate portion 64A of the first carrier 64 is fixed to the bottom wall portion 16A of the motor case 16. Further, an inner race of the second sealed bearing 21 is locked to a radially outer periphery of the base plate portion 64A of the first carrier 64.

The first sun gear 66 is arranged radially inside the three first planetary gears 62 to mesh with them. The first sun gear 66 is fixed, by press fitting or the like, to the shaft member 74 that is formed in a cylindrical shape and arranged coaxially with the output shaft 12. In the present embodiment, the module and the pitch circle diameter of the first sun gear 66 are set to be respectively larger than the module and the pitch circle diameter of the second sun gear 72 that will be described later.

The second planetary gears 68 are arranged radially inside a part of the ring gear 60 on the first side in the axial direction. More particularly, in the present embodiment, there are arranged three second planetary gears 68 at equal intervals along the circumferential direction. In addition, the second planetary gears 68 each mesh with the second internal teeth 60B of the ring gear 60. Furthermore, in the present embodiment, the second planetary gears 68 are opposed to the above-described first planetary gears 62 via the reduced-diameter portion 60C of the ring gear 60 in the axial direction.

The second carrier 70 has a base plate portion 70A formed in a discoid shape, and three shaft portions 70B protruding from the base plate portion 70A to the second side in the axial direction and arranged at equal intervals in the circumferential direction. The three shaft portions 70B respectively rotatably support the three second planetary gears 68. In addition, the second planetary gears 68 are arranged adjacent to the reduced-diameter portion 60C of the ring gear 60; thus, the second planetary gears 68 are restricted by the reduced-diameter portion 60C of the ring gear 60 from moving in a direction of being detached from the shaft portions 70B of the second carrier 70. Moreover, at the axial center of the base plate portion 70A, there is formed a recess 70C that is open on the second side in the axial direction. To an inner periphery of the recess 70C, there is fixed, by press fitting or the like, a bearing 76 to support an end portion of the shaft member 74 on the first side in the axial direction. Furthermore, the output shaft 12 protrudes from a radially central part of the base plate portion 70A of the second carrier 70 to the first side in the axial direction. That is, the second carrier 70 is formed integrally with the output shaft 12 into one piece.

The second sun gear 72 is arranged radially inside the three second planetary gears 68 to mesh with them. The second sun gear 72 is fixed to the shaft member 74 by press fitting or the like. Consequently, a sun gear assembly 78 is formed by the second sun gear 72, the first sun gear 66 and the shaft member 74 so that the second sun gear 72 can rotate together with the first sun gear 66.

Next, the detailed configuration of the stator 20 will be described.

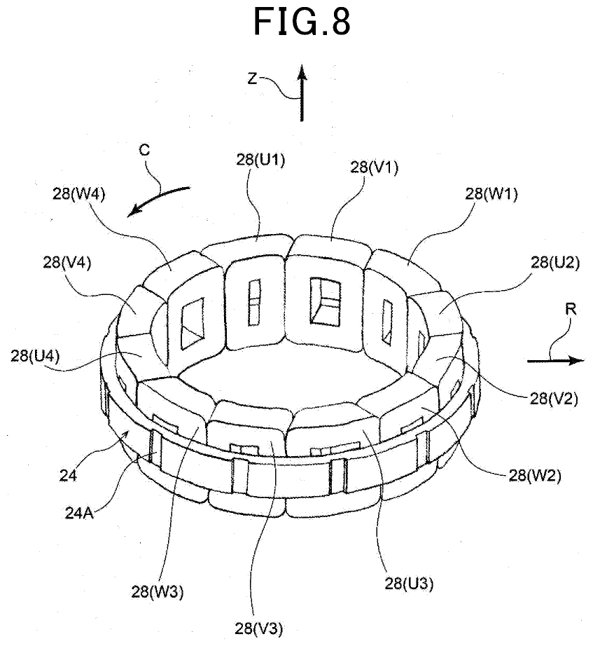

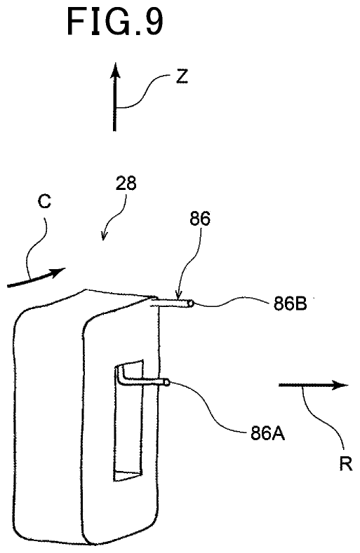

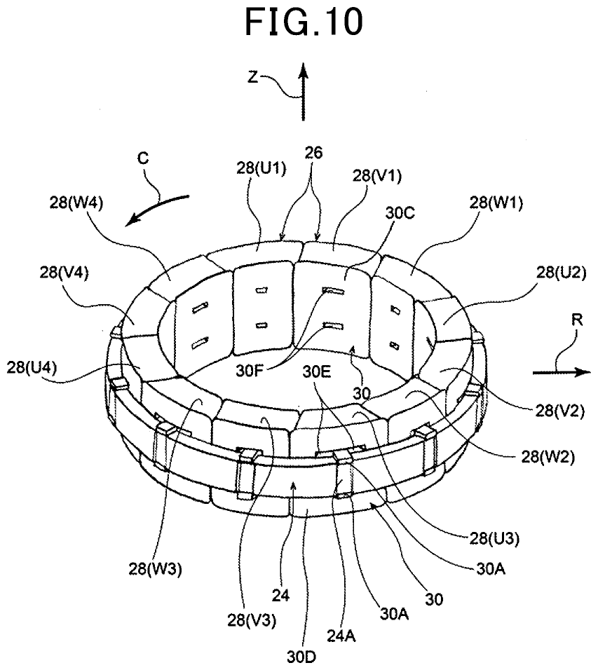

FIG. 8 shows the coils 28 and the stator core 24 of the stator 20 (see FIG. 2), omitting the insulators 30 provided for the coils 28. FIG. 9 shows one of the coils 28, omitting the corresponding insulator 30 provided for the coil 28. Moreover, as shown in FIGS. 10 to 12, each of the coils 28 is formed around the corresponding one of the insulators 30. Further, each of the coils 28 is mounted, along the inner circumferential surface of the stator core 24, to the stator core 24 via the corresponding insulator 30. That is, each of the coil units 26 is mounted along the inner circumferential surface of the stator core 24 to the stator core 24.

As shown in FIG. 8, the stator core 24 is formed of a magnetic material, such as iron or steel, into in an annular shape. Moreover, a cross section of the stator core 24 obtained by cutting the stator 20 along the axial direction has a rectangular shape whose longitudinal direction coincides with the vertical direction in FIG. 8. The radially inner surface (i.e., inner circumferential surface) of the stator core 24 is formed as a cylindrical surface that is smooth in both the circumferential direction and the axial direction. On the other hand, in the radially outer surface (i.e., the outer circumferential surface) of the stator core 24, there are formed a plurality of locking grooves 24A each extending continuously in the axial direction. Specifically, each of the locking grooves 24A is recessed radially inward from the radially outer surface of the stator core 24. Moreover, the locking grooves 24A are spaced at predetermined intervals along the circumferential direction.

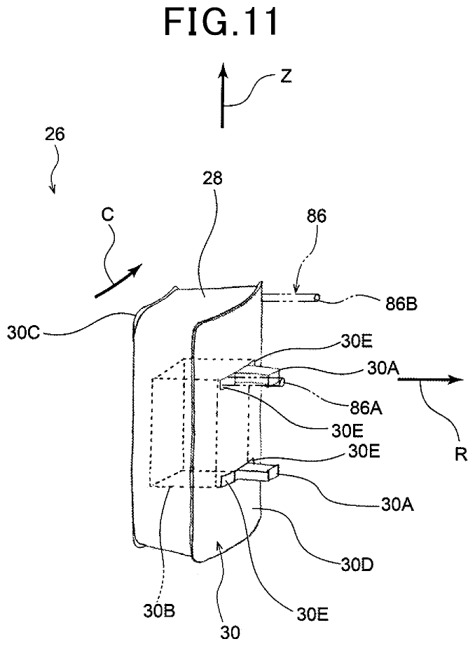

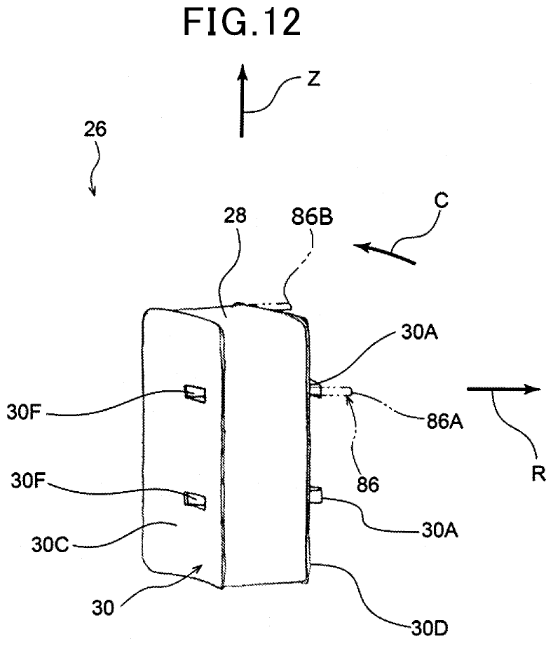

As shown in FIGS. 11 and 12, each of the insulators 30 is formed of an electrically insulative material such as a resin material. Each of the insulators 30 has a winding portion 30B around which a conductor wire 86 forming the corresponding coil 28 is wound. Moreover, each of the insulators 30 also has an inner extending portion 30C that is arranged to radially face the rotor 22 (see FIG. 4); and an axially and circumferentially central part of a radially outer surface of the inner extending portion 30C is connected with a radially inner end of the winding portion 30B. Furthermore, each of the insulators 30 further has an intervening portion 30D that is arranged to radially face the stator core 24 (see FIG. 10); and an axially and circumferentially central part of a radially inner surface of the intervening portion 30D is connected with a radially outer end of the winding portion 30B. The inner extending portion 30C and the intervening portion 30D are each formed in the shape of a thin plate curved along the circumferential direction. Moreover, each of the insulators 30 also has a pair of locking portions 30A protruding radially outward from a circumferentially central part of the intervening portion 30D. The pair of locking portions 30A are spaced apart in the axial direction. As shown in FIG. 10, each of the coils 28 is mounted to the stator core 24 via the corresponding insulator 30, with the stator core 24 arranged between the pair of locking portions 30A of the corresponding insulator 30 and with radially outer end portions of the pair of locking portions 30A locked into a corresponding one of the locking grooves 24A of the stator core 24. Moreover, as shown in FIGS. 11 and 12, each of the insulators 30 has openings 30E formed on both circumferential sides of the pair of locking portions 30A in the intervening portion 30D; the openings 30E communicate with an inner peripheral portion side of the corresponding coil 28. Furthermore, each of the insulators 30 also has openings 30F formed, in the inner extending portion 30C, at positions circumferentially and axially corresponding to the openings 30E formed in the intervening portion 30D; the openings 30F also communicate with the inner peripheral portion side of the corresponding coil 28. It should be noted that each of the insulators 30 may not have the openings 30F formed therein.

As shown in FIGS. 9, 11 and 12, each of the coils 28 is formed by winding an electrically-conductive conductor wire 86 around the winding portion 30B of the corresponding insulator 30. A first end portion 86A, which is one end portion of the conductor wire 86 forming the coil 28, protrudes from an inner peripheral portion of the coil 28 radially outward through one of the openings 30E formed on the first side in the axial direction in the intervening portion 30D of the corresponding insulator 30. Consequently, when viewed from the radially outer side, the first end portion 86A radially protrudes from a gap between an end of the stator core 24 on the first side in the axial direction and the coil 28. On the other hand, a second end portion 86B, which is the other end portion of the conductor wire 86 forming the coil 28, protrudes from an outer peripheral portion of the coil 28 on the first side in the axial direction radially outward along an outer edge of the intervening portion 30D of the corresponding insulator 30. In addition, the number of turns and the shape of the coils 28 may be suitably set in consideration of torque characteristics required for the speed reducer-equipped motor 10.

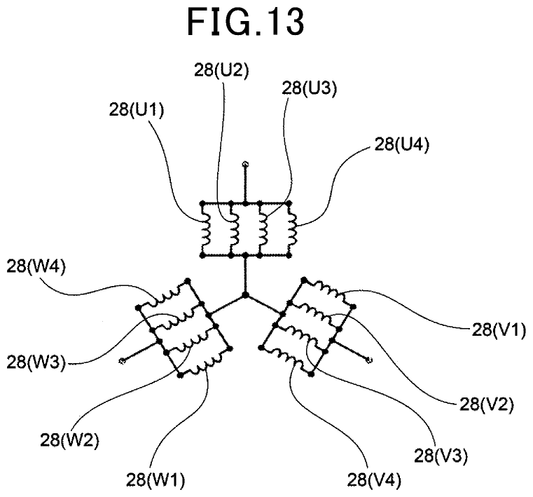

As shown in FIG. 10, in the present embodiment, the U-phase coils 28, the V-phase coils 28 and the W-phase coils 28 are arranged in this order along the circumferential direction. In addition, the four U-phase coils 28 are respectively designated by reference signs U1, U2, U3 and U4 in order along the circumferential direction; the four V-phase coils 28 are respectively designated by reference signs V1, V2, V3 and V4 in order along the circumferential direction; and the four W-phase coils 28 are respectively designated by reference signs W1, W2, W3 and W4 in order along the circumferential direction. As shown in FIG. 13, in the present embodiment, the U-phase, V-phase and W-phase coils 28 are star-connected with each other.

More specifically, as shown in FIG. 14, in the present embodiment, all the first end portions 86A of the U-phase, V-phase and W-phase coils 28 are connected with each other via a neutral connecting member 88C that is formed in an annular shape and defines a neutral point between the coils 28. On the other hand, all the second end portions 86B of the four U-phase coils 28 are connected with each other via a U-phase connecting member 88U that is curved in a substantially C-shape in an axial view; all the second end portions 86B of the four V-phase coils 28 are connected with each other via a V-phase connecting member 88V that is curved in a substantially C-shape in an axial view; and all the second end portions 86B of the four W-phase coils 28 are connected with each other via a W-phase connecting member 88W that is curved in a substantially C-shape in an axial view. In addition, electric currents flowing through the U-phase connecting member 88U, the V-phase connecting member 88V and the W-phase connecting member 88W are controlled by a control unit (not shown).

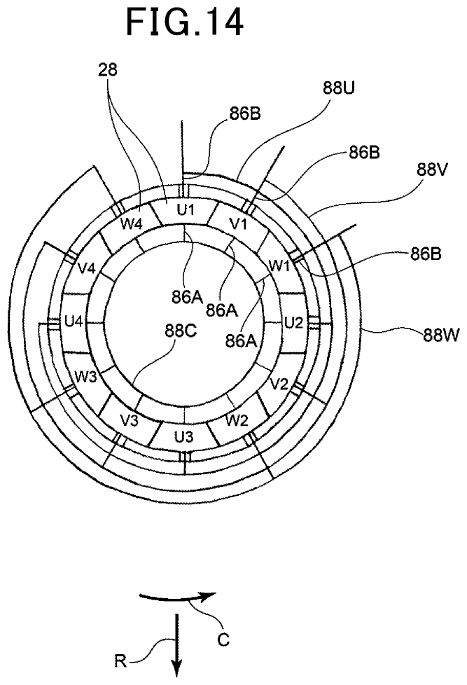

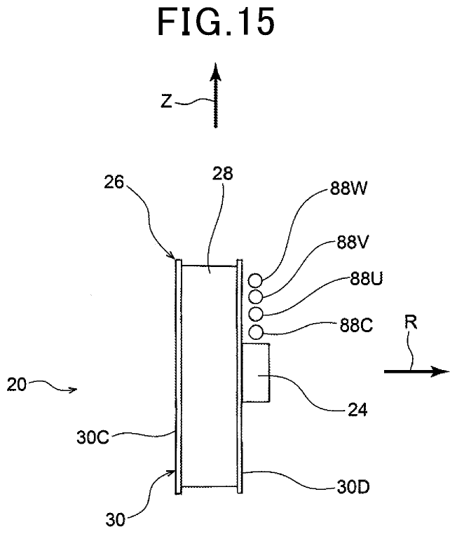

As shown in FIG. 15, in the present embodiment, the neutral connecting member 88C, the U-phase connecting member 88U, the V-phase connecting member 88V and the W-phase connecting member 88W are arranged so as to be stacked on the stator core 24 in the axial direction on the first side in the axial direction with respect to the stator core 24. It should be noted that the stacking order of these connecting members may be arbitrarily set. For example, in the present embodiment, the W-phase connecting member 88W, the V-phase connecting member 88V, the U-phase connecting member 88U and the neutral connecting member 88C are stacked in this order from the first side to the second side in the axial direction. In addition, for ease of viewing, the neutral connecting member 88C is depicted as being located radially inside the coils 28 in FIG. 14; however, the neutral connecting member 88C is actually located radially outside the coils 28 as shown in FIG. 15.

Next, operation and effects of the present embodiment will be described.

As shown in FIGS. 1 to 7, in the above-described speed reducer-equipped motor 10 according to the present embodiment, energization of the coils 28 of the coil units 26 of the stator 20 is switched by a control circuit (not shown), causing the stator 20 to generate a rotating magnetic field. Consequently, the rotor 22 is caused by the rotating magnetic field to rotate; thus, the ring gear 60 rotates together with the magnet 32.

Further, with the rotation of the ring gear 60, the three first planetary gears 62, which mesh with the first internal teeth 60A of the ring gear 60, also rotate.

Furthermore, with the rotation of the three first planetary gears 62, the first sun gear 66, which meshes with the three first planetary gears 62, rotates together with the second sun gear 72.

Furthermore, with the rotation of the second sun gear 72, the three second planetary gears 68, which mesh with the second sun gear 72, also rotate. Moreover, the three second planetary gears 68 also mesh with the ring gear 60. Therefore, the three second planetary gears 68 revolve around the second sun gear 72 at a speed corresponding to both the rotational speed of the second sun gear 72 and the rotational speed of the ring gear 60. Consequently, the second carrier 70, which supports the three second planetary gears 68, rotates together with the output shaft 12 at a rotational speed corresponding to the revolution of the three second planetary gears 68.

In the speed reducer-equipped motor 10 according to the present embodiment, as shown in FIG. 9, each of the coils 28 is formed by winding an electrically-conductive conductor wire 86 into a ring shape. Further, in each of the coils 28, the first end portion 86A of the conductor wire 86 forming the coil 28 protrudes radially outward from the inner peripheral portion of the coil 28; and the second end portion 86B of the conductor wire 86 forming the coil 28 protrudes radially outward from the outer peripheral portion of the coil 28 on the first side in the axial direction. Moreover, in the speed reducer-equipped motor 10 according to the present embodiment, all the coils 28 are arranged side by side along the circumferential direction. Consequently, it becomes unnecessary to shape the coils 28 as in the case of arranging the coils 28 to partially radially overlap one another; it also becomes unnecessary to shape the coils 28 so as to avoid the first end portions 86A and the second end portions 86B of the coils 28. As a result, the shape of the coils 28 is prevented from becoming complicated.

Moreover, in the present embodiment, as shown in FIG. 10, each of the coils 28 can be easily mounted to the stator core 24 via the corresponding insulator 30 by locking the radially outer end portions of the pair of locking portions 30A of the corresponding insulator 30 into the corresponding locking grooves 24A of the stator core 24.

Furthermore, in the present embodiment, as shown in FIGS. 14 and 15, the first and second end portions 86A and 86B of the coils 28 are connected via the neutral connecting member 88C, the U-phase connecting member 88U, the V-phase connecting member 88V and the W-phase connecting member 88W that are arranged so as to be stacked on the stator core 24 in the axial direction on the first side in the axial direction with respect to the stator core 24. Consequently, it becomes possible to effectively utilize the space between the coils 28 and the side wall portion 16B (see FIG. 2) of the motor case 16 on the first side in the axial direction with respect to the stator core 24, thereby suppressing increase in the axial and radial sizes of the speed reducer-equipped motor 10. Moreover, it also becomes possible to reduce the radial distances between the coils 28 and the neutral connecting member 88C, the U-phase connecting member 88U, the V-phase connecting member 88V and the W-phase connecting member 88W, thereby shortening the wiring distances therebetween. Furthermore, with the intervening portions 30D of the corresponding insulators 30 intervening between the coils 28 and the neutral connecting member 88C, the U-phase connecting member 88U, the V-phase connecting member 88V and the W-phase connecting member 88W, it becomes possible to easily secure electrical insulation therebetween.

### Second Embodiment

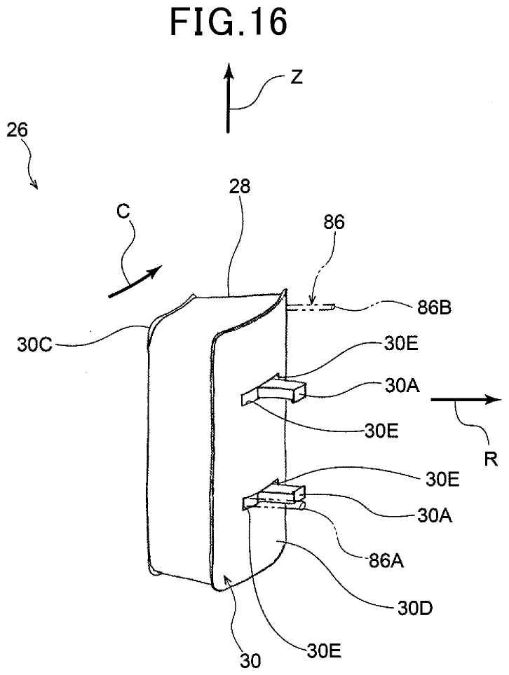

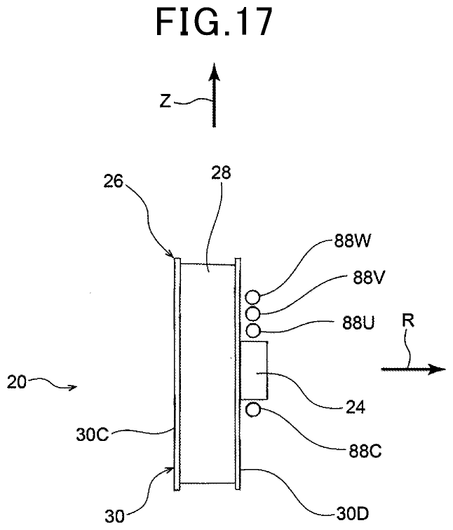

Next, the configuration of a motor according to the second embodiment of the present disclosure will be described with reference to FIGS. 16 and 17. It should be noted that: in the motor according to the second embodiment, members and portions corresponding to those in the speed reducer-equipped motor 10 according to the first embodiment are designated by the same reference signs as the corresponding members and portions in the speed reducer-equipped motor 10 according to the first embodiment; and explanation thereof will be omitted hereinafter.

As shown in FIGS. 16 and 17, in the motor according to the present embodiment, the stator 20 is configured with a plurality of coil units 26 in each of which: the first end portion 86A of the conductor wire 86 forming the coil 28 protrudes from the inner peripheral portion of the coil 28 radially outward through one of the openings 30E formed on the second side in the axial direction in the intervening portion 30D of the corresponding insulator 30. Moreover, in the present embodiment, the neutral connecting member 88C, via which the first end portions 86A of the coils 28 are connected with each other, is arranged so as to be stacked on the stator core 24 in the axial direction on the second side in the axial direction with respect to the stator core 24. On the other hand, the U-phase, V-phase and W-phase connecting members 88U, 88V and 88W, via which the second end portions 86B of the coils 28 are connected in a predetermined manner, are arranged so as to be stacked on the stator core 24 in the axial direction on the first side in the axial direction with respect to the stator core 24.

In the motor according to the present embodiment, with the neutral connecting member 88C arranged at the above-described location, it becomes possible to effectively utilize the space between the coils 28 and the side wall portion 16B (see FIG. 2) of the motor case 16 on the second side in the axial direction with respect to the stator core 24, thereby suppressing increase in the axial and radial sizes of the motor. Moreover, in the motor according to the present embodiment, with the neutral connecting member 88C and the U-phase, V-phase and W-phase connecting members 88U, 88V and 88W arranged respectively at the above-described locations, it becomes possible to easily secure electrical insulation between the neutral connecting member 88C that defines the neutral point and the U-phase, V-phase and W-phase connecting members 88U, 88V and 88W on the power line side.

### Third Embodiment

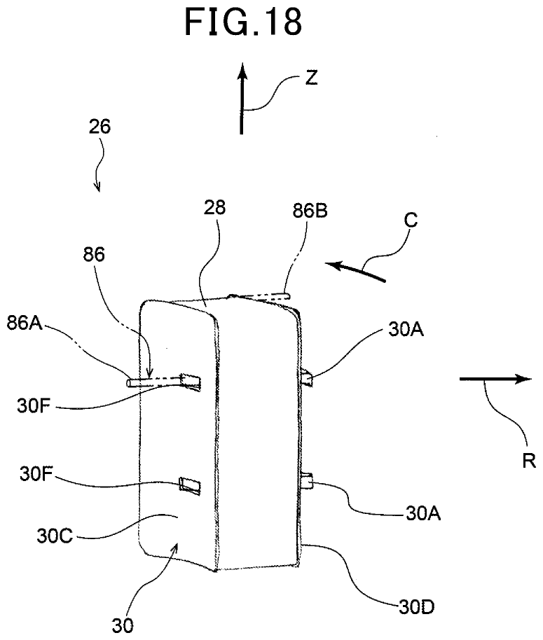

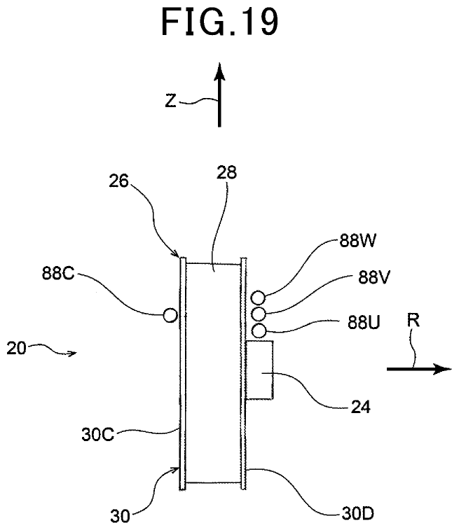

Next, the configuration of a motor according to the third embodiment of the present disclosure will be described with reference to FIGS. 18 and 19. It should be noted that: in the motor according to the third embodiment, members and portions corresponding to those in the speed reducer-equipped motors 10 according to the previous embodiments are designated by the same reference signs as the corresponding members and portions in the speed reducer-equipped motors 10 according to the previous embodiments; and explanation thereof will be omitted hereinafter.

As shown in FIGS. 18 and 19, in the motor according to the present embodiment, the stator 20 is configured with a plurality of coil units 26 in each of which: the first end portion 86A of the conductor wire 86 forming the coil 28 protrudes from the inner peripheral portion of the coil 28 radially inward through the opening 30F formed on the first side in the axial direction in the inner extending portion 30C of the corresponding insulator 30. Moreover, in the present embodiment, the neutral connecting member 88C, via which the first end portions 86A of the coils 28 are connected with each other, is arranged along the radially inner surfaces of the inner extending portions 30C of the insulators 30. On the other hand, the U-phase, V-phase and W-phase connecting members 88U, 88V and 88W, via which the second end portions 86B of the coils 28 are connected in a predetermined manner, are arranged so as to be stacked on the stator core 24 in the axial direction on the first side in the axial direction with respect to the stator core 24.

In the motor according to the present embodiment, with the neutral connecting member 88C arranged at the above-described location, it becomes possible to effectively utilize the space on the radially inner side of the coils 28 and on the first side in the axial direction with respect to the magnet 32 (see FIG. 2) of the rotor 22, thereby suppressing increase in the axial and radial sizes of the motor. Moreover, in the motor according to the present embodiment, with the neutral connecting member 88C and the U-phase, V-phase and W-phase connecting members 88U, 88V and 88W arranged respectively at the above-described locations, it becomes possible to easily secure electrical insulation between the neutral connecting member 88C that defines the neutral point and the U-phase, V-phase and W-phase connecting members 88U, 88V and 88W on the power line side. Furthermore, with the use of the coil units 26 having the above-described configuration, it becomes possible to arrange all the connecting members on the first side in the axial direction with respect to the stator core 24. Consequently, it becomes possible to perform both the connection between the first end portions 86A of the coils 28 and the connection between the second end portions 86B of the coils 28 on the first side in the axial direction with respect to the stator core 24.

### Fourth Embodiment

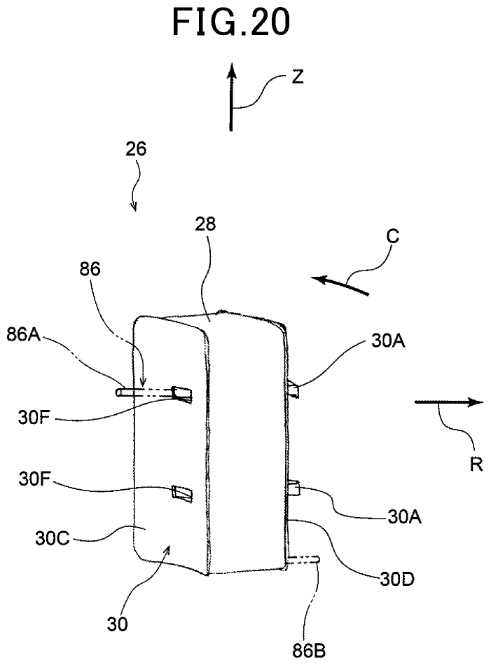

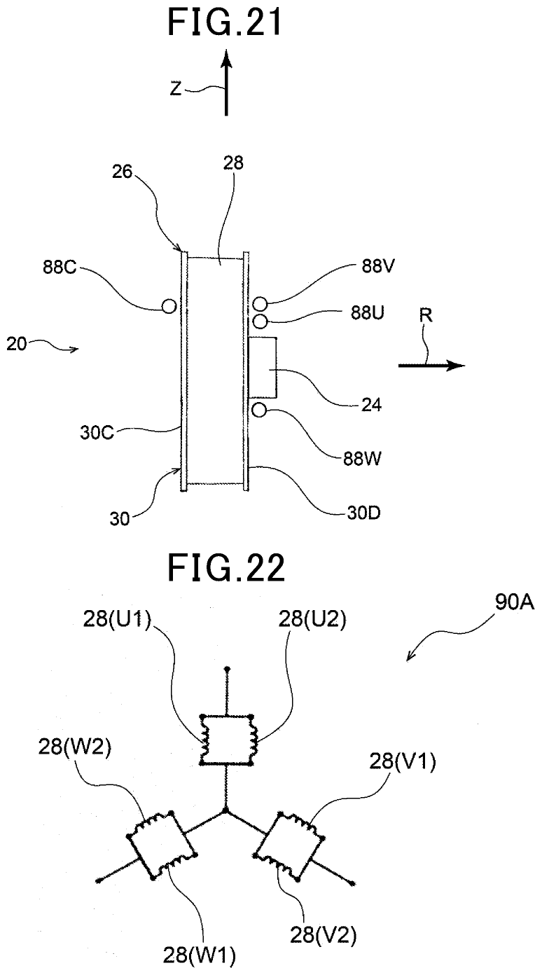

Next, the configuration of a motor according to the fourth embodiment of the present disclosure will be described with reference to FIGS. 20 and 21. It should be noted that: in the motor according to the fourth embodiment, members and portions corresponding to those in the speed reducer-equipped motors 10 according to the previous embodiments are designated by the same reference signs as the corresponding members and portions in the speed reducer-equipped motors 10 according to the previous embodiments; and explanation thereof will be omitted hereinafter.

As shown in FIGS. 20 and 21, in the motor according to the present embodiment, the stator 20 is configured with two types of coil units 26. Specifically, in each of the first-type coil units 26, as shown in FIG. 20, the second end portion 86B of the conductor wire 86 forming the coil 28 protrudes from an outer peripheral portion of the coil 28 on the second side in the axial direction radially outward along an outer edge of the intervening portion 30D of the corresponding insulator 30. On the other hand, the second-type coil units 26 are identical to the coil units 26 described in the third embodiment with reference to FIG. 18. Further, the coils 28 of the first-type coil units 26 constitute the W-phase coils 28, while the coils 28 of the second-type coil units 26 constitute the U-phase and W-phase coils 28. Moreover, in the present embodiment, as shown in FIG. 21, the neutral connecting member 88C, via which the first end portions 86A of the coils 28 are connected with each other, is arranged along the radially inner surfaces of the inner extending portions 30C of the insulators 30. On the other hand, the U-phase and V-phase connecting members 88U and 88V, via which the second end portions 86B of the coils 28 of the second-type coil units 26 are connected in a predetermined manner, are arranged so as to be stacked on the stator core 24 in the axial direction on the first side in the axial direction with respect to the stator core 24; and the W-phase connecting member 88W, via which the second end portions 86B of the coils 28 of the first-type coil units 26 are connected in a predetermined manner, is arranged so as to be stacked on the stator core 24 in the axial direction on the second side in the axial direction with respect to the stator core 24.

In the motor according to the present embodiment, the neutral connecting member 88C, the U-phase connecting member 88U, the V-phase connecting member 88V and the W-phase connecting member 88W are distributed at the above-described three locations. Consequently, it becomes possible to more easily secure the arrangement spaces of the connecting members as compared with the motor according to the third embodiment.

### Fifth Embodiment

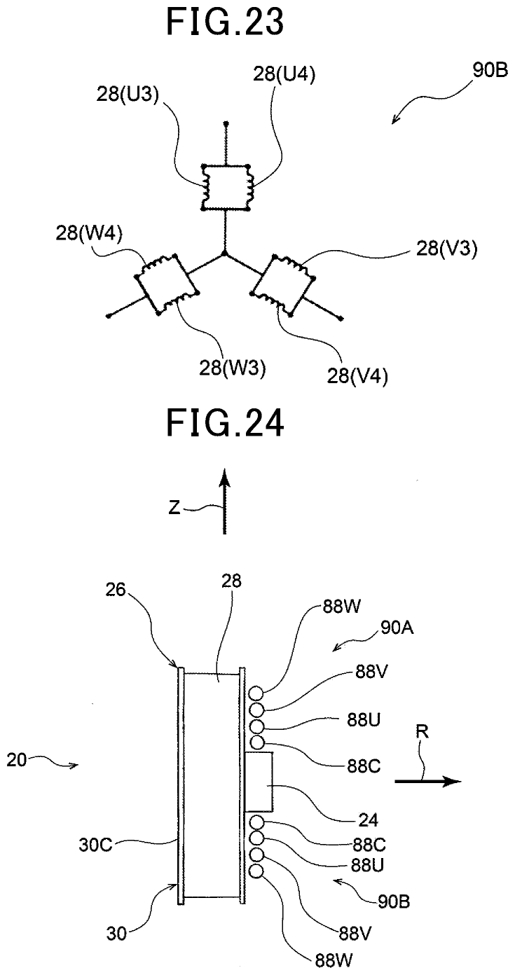

Next, the configuration of a motor according to the fifth embodiment of the present disclosure will be described with reference to FIGS. 22 to 24. It should be noted that: in the motor according to the fifth embodiment, members and portions corresponding to those in the speed reducer-equipped motors 10 according to the previous embodiments are designated by the same reference signs as the corresponding members and portions in the speed reducer-equipped motors 10 according to the previous embodiments; and explanation thereof will be omitted hereinafter.

As shown in FIGS. 22 to 24, in the present embodiment, the stator 20 includes: U-phase coils 28, V-phase coils 28 and W-phase coils 28 of a first system 90A which are star-connected with each other; and U-phase coils 28, V-phase coils 28 and W-phase coils 28 of a second system 90B which are also star-connected with each other. Moreover, in the present embodiment, the stator 20 is configured with two types of coil units 26. Specifically, the first-type coil units 26 are identical to the coil units 26 described in the first embodiment with reference to FIG. 11. On the other hand, the second-type coil units 26 have a shape obtained by inverting the shape of the first-type coil units 26 in the axial direction. Further, the coils 28 of the first-type coil units 26 constitute the U-phase, V-phase and W-phase coils 28 of the first system 90A, while the coils 28 of the second-type coil units 26 constitute the U-phase, V-phase and W-phase coils 28 of the second system 90B. Furthermore, in the present embodiment, the stator 20 also includes: a neutral connecting member 88C of the first system 90A via which the first end portions 86A of the coils 28 of the first system 90A are connected with each other; U-phase, V-phase and W-phase connecting members 88U, 88V and 88W of the first system 90A via which the second end portions 86B of the coils 28 of the first system 90A are connected in a predetermined manner; a neutral connecting member 88C of the second system 90B via which the first end portions 86A of the coils 28 of the second system 90B are connected with each other; and U-phase, V-phase and W-phase connecting members 88U, 88V and 88W of the second system 90B via which the second end portions 86B of the coils 28 of the second system 90B are connected in a predetermined manner. Further, all of the neutral connecting member 88C, the U-phase connecting member 88U, the V-phase connecting member 88V and the W-phase connecting member 88W of the first system 90A are arranged so as to be stacked on the stator core 24 in the axial direction on the first side in the axial direction with respect to the stator core 24. On the other hand, all of the neutral connecting member 88C, the U-phase connecting member 88U, the V-phase connecting member 88V and the W-phase connecting member 88W of the second system 90B are arranged so as to be stacked on the stator core 24 in the axial direction on the second side in the axial direction with respect to the stator core 24.

In the motor according to the present embodiment, the connecting members that connect the coils 28 of the first system 90A are separated by the stator core 24 in the axial direction from the connecting members that connect the coils 28 of the second systems 90B.

Moreover, in the motor according to the present embodiment, even when the coils 28 of one of the first and second systems 90A and 90B cannot be energized, it is still possible to ensure energization of the coils 28 of the other of the first and second systems 90A and 90B. In addition, the coils 28 of the first and second systems 90A and 90B may be arranged so that the coils 28 of the first system 90A are offset from the coils 28 of the second systems 90B by 180° in the circumferential direction. Alternatively, the coils 28 of the first and second systems 90A and 90B may be arranged so that the slots where the coils 28 of the first system 90A are arranged alternate in the circumferential direction with the slots where the coils 28 of the second systems 90B are arranged.

### Sixth Embodiment

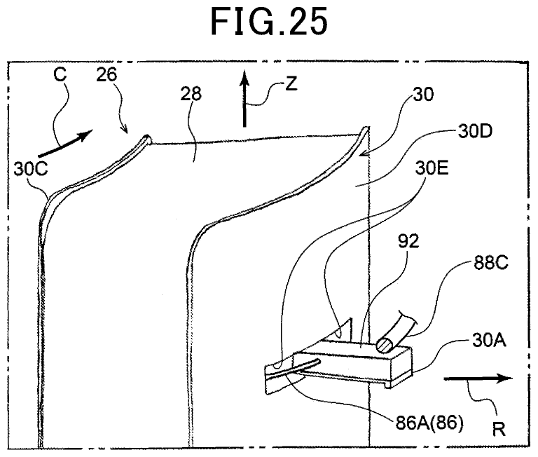

Next, the configuration of a motor according to the sixth embodiment of the present disclosure will be described with reference to FIG. 25. It should be noted that: in the motor according to the sixth embodiment, members and portions corresponding to those in the speed reducer-equipped motors 10 according to the previous embodiments are designated by the same reference signs as the corresponding members and portions in the speed reducer-equipped motors 10 according to the previous embodiments; and explanation thereof will be omitted hereinafter.

As shown in FIG. 25, in the motor according to the present embodiment, to one of the locking portions 30A of each of the insulators 30, there is fixed an electrically-conductive terminal member 92 on a side of the locking portion 30A opposite to the side where the locking portion 30A makes contact with the stator core 24 (see FIG. 8).

With the above configuration, it is possible to connect the first end portion 86A of each of the coils 28 to the terminal member 92 fixed to one of the locking portions 30A of the corresponding insulator 30. Moreover, it is also possible to connect, via the neutral connecting member 88C, all the terminal members 92 fixed to the locking portions 30A of the insulators 30 with each other in the circumferential direction; thus, it is possible to connect all the first end portions 86A of the coils 28 with each other.

### Seventh Embodiment

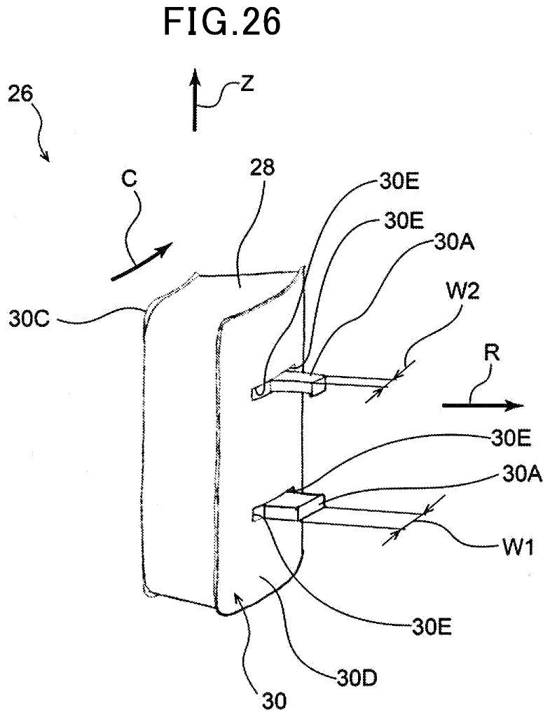

Next, the configuration of a motor according to the seventh embodiment of the present disclosure will be described with reference to FIG. 26. It should be noted that: in the motor according to the seventh embodiment, members and portions corresponding to those in the speed reducer-equipped motors 10 according to the previous embodiments are designated by the same reference signs as the corresponding members and portions in the speed reducer-equipped motors 10 according to the previous embodiments; and explanation thereof will be omitted hereinafter.

As shown in FIG. 26, in the motor according to the present embodiment, in each of the insulators 30, a circumferential width W1 of the locking portion 30A on the second side in the axial direction is set to be larger than a circumferential width W2 of the locking portion 30A on the first side in the axial direction.

In the motor according to the present embodiment, with the circumferential widths W1 and W2 of the pair of locking portions 30A in each of the insulators 30 set as described above, it becomes possible to easily grasp, by the pair of locking portions 30A, the posture of the coil unit 26 in the axial direction when the pair of locking portions 30A are locked to the stator core 24 (see FIG. 8). Consequently, it becomes possible to prevent each of the coil units 26 from being incorrectly assembled to the stator core 24.

In the above-described embodiments, the coils 28 are star-connected with each other. However, the present disclosure is not limited to this configuration. For example, the coils 28 may alternatively be A-connected with each other.

In the above-described embodiments, the first end portions 86A of the coils 28 are connected together to define the neutral point between the coils 28. However, the present disclosure is not limited to this configuration. For example, instead of the first end portions 86A, the second end portions 86B of the coils 28 may be connected together to define the neutral point between the coils 28.

The configurations of the motors according to the above-described embodiments may be combined with each other. Moreover, the configurations of the motors according to the present disclosure may be applied to motors which include no speed reducer.

While the above particular embodiments of the present disclosure have been shown and described, it will be understood by those skilled in the art that the present disclosure is not limited to the above particular embodiments, but may be carried out through various modifications without departing from the spirit of the present disclosure.

Moreover, while the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. A motor comprising:
a rotor rotatably supported and including a magnet; and
a stator radially opposed to the rotor, the stator including a plurality of coils each of which is formed by winding an electrically-conductive conductor wire in a ring shape, the coils being arranged along a circumferential direction,
wherein
for each of the coils, the conductor wire forming the coil has a first end portion radially protruding from an inner peripheral portion of the coil and a second end portion radially protruding from an outer peripheral portion of the coil.

2. The motor as set forth in claim 1, wherein:
the stator further includes an annular stator core;
the coils are arranged along an inner circumferential surface or an outer circumferential surface of the stator core; and
for each of the coils, the first end portion of the conductor wire forming the coil radially protrudes from a gap between the coil and an end of the stator core in an axial direction.

3. The motor as set forth in claim 2, wherein:
for each of the coils, the first end portion of the conductor wire forming the coil radially protrudes from the inner peripheral portion of the coil to the stator core side; and
the second end portion of the conductor wire forming the coil radially protrudes from the outer peripheral portion of the coil to the stator core side.

4. The motor as set forth in claim 3, wherein
at least one of a first end portion group consisting of the first end portions of the conductor wires forming the coils and a second end portion group consisting of the second end portions of the conductor wires forming the coils is connected via a connecting member that is arranged to overlap the stator core in the axial direction.

5. The motor as set forth in claim 4, wherein:
the first end portions of the conductor wires forming the coils are connected with each other via a connecting member that is arranged on one side in the axial direction with respect to the stator core; and
the second end portions of the conductor wires forming the coils are connected with each other via a connecting member that is arranged on the other side in the axial direction with respect to the stator core.

6. The motor as set forth in claim 2, wherein:
for each of the coils, the first end portion of the conductor wire forming the coil protrudes from the inner peripheral portion of the coil to one side in a radial direction; and
the second end portion of the conductor wire forming the coil protrudes from the outer peripheral portion of the coil to the other side in the radial direction.

7. The motor as set forth in claim 6, wherein:
one of a first end portion group consisting of the first end portions of the conductor wires forming the coils and a second end portion group consisting of the second end portions of the conductor wires forming the coils is connected via a connecting member that is arranged to overlap the stator core in the axial direction; and
the other of the first end portion group and the second end portion group is connected via a connecting member that is arranged on a radially opposite side of the coils to the stator core.

8. The motor as set forth in claim 2, wherein:
the coils comprise U-phase, V-phase and W-phase coils of a first system and U-phase, V-phase and W-phase coils of a second system;
the U-phase, V-phase and W-phase coils of the first system are connected with each other on one side in the axial direction with respect to the stator core; and
the U-phase, V-phase and W-phase coils of the second system are connected with each other on the other side in the axial direction with respect to the stator core.

9. The motor as set forth in claim 2, wherein
the second end portions of some of the conductor wires forming the coils are arranged on an axially opposite side to the second end portions of the remainder of the conductor wires forming the coils.

10. The motor as set forth in claim 2, wherein
each of the coils is formed around an insulator that has:
a winding portion around which the conductor wire forming the coil is wound;
an intervening portion located between the coil and the stator core; and
a locking portion formed integrally with the intervening portion into one piece and locked to the stator core.

11. The motor as set forth in claim 10, wherein
to the locking portion, there is fixed an electrically-conductive terminal member on a side of the locking portion opposite to a side where the locking portion is in contact with the stator core.

12. The motor as set forth in claim 1, wherein
the second end portions of some of the conductor wires forming the coils are arranged on an axially opposite side to the second end portions of the remainder of the conductor wires forming the coils.
